(19) United States
(12) Patent Application Publication
(10) Pub. No.: US 2015/0339269 A1
(43) Pub. Date: Nov. 26, 2015

(54) SYSTEM AND METHOD FOR GENERATING FLOWCHART FROM A TEXT DOCUMENT USING NATURAL LANGUAGE PROCESSING

(71) Applicants: Alon Konchitsky, Cupertino, CA (US); Kevin Dankwardt, Cupertino, CA (US)

(72) Inventors: Alon Konchitsky, Cupertino, CA (US); Kevin Dankwardt, Cupertino, CA (US)

(73) Assignee: Alon Konchitsky, Cupertino, CA (US)

(21) Appl. No.: 14/286,082

(22) Filed: May 23, 2014

(51) Int. Cl. G06F 17/21; G06F 17/28; G06T 11/20; G06F 17/27

(52) U.S. Cl. CPC G06F 17/212; G06F 17/2785; G06F 17/289; G06T 11/206; G06F 17/28; G06T 2207/30176

(57) ABSTRACT

A system and method for converting an unstructured document to a plurality of flowcharts using natural language processing is disclosed. The system comprises a processor, a memory coupled to the processor. The memory can store a database, which maintains a plurality of unstructured documents to be converted into flowcharts. Further, the system enables a plurality of instructions executable by the processor for natural language processing to parse the unstructured document into a plurality of events and identify a plurality of parameters associated with the events. Further, the system identifies correlation and execution sequences between the plurality of events using the plurality of parameters. A parsed document is created which also maintains correlation and execution sequence of events in a structured format such as a binary tree structure. The parsed document is then used to generate a pictorially representation such as flowchart representing the execution sequence of the events.

### FIELD OF THE INVENTION

The Invention relates to data transformation, more specifically the invention relates to transforming a text document to a flowchart using natural language processing.

### BACKGROUND OF THE INVENTION

Text documents are difficult to analyze and interpret especially when the user who is reading these documents is not familiar with the concept disclosed by the document. For instance when a person from a science background tries to interpret a legal document, it is very difficult for him to interpret the legal terms that are present in a legal document. Further, the text documents are not systematically arranged which makes the task of interpretation much more difficult. To address this problem most of the scientific publications include figures, flowcharts, and other graphical representation to make the document more readable. However, this approach is not feasible for legal and business documents which include contractual terms and multiple scenarios associated with the legal aspects.

A new field of Natural language Processing (NLP) is been developed in order to interpret these documents and convert them into structured format. The structured format can be easily interpreted by machines such as computers. Some of the documents available on web are structured documents where data is arranged systematically. However it is difficult for users to interpret these structured documents. Further, there is no NLP system developed which can convert the text document into such a format which is easy for humans to interpret.

Another representation which is commonly adapted for understanding the complexity of a software system is the UML diagrams. UML diagrams graphically represent the elements and their correlation between them. This makes the user easily understand the structure of the system and can easily interpret each of the elements in the system. The UML diagrams can be easily interpreted by machines for the purpose of development of source code. However, construction of UML diagrams cannot be automated and are difficult to interpret by a new user. Further, the concept of generating UML diagrams cannot be applied over legal document and legal contracts.

As discussed above the existing system has various limitations related to processing of text data and ease of representation for human interpretation. Thus there is a need in the system to develop a NLP system which can interpret the events in a legal document and accordingly generate graphical representation such as flowcharts which can be easily interpreted by new users.

### SUMMARY

An aspect of the invention is to enable a NLP system to extract a plurality of events present in an unstructured document.

Another aspect of the invention is to enable a NLP system to identifying correlation and execution sequence between the plurality of events, using the plurality of parameters associated with each of the events.

Yet another aspect of the invention is to enable a NLP system to generate a parsed document storing the plurality of events with the correlation and execution sequence associated therewith in a structured format.

Another aspect of the invention is to enable a NLP system wherein the parsed document stores the structured format is a binary tree structure.

Another aspect of the invention is to enable a NLP system to pictorially represent the execution sequence of the events captured in the parsed document.

A system and method for converting an unstructured document to a plurality of flowchart using natural language processing is disclosed. The system comprises a processor, a memory coupled to the processor. The memory is further enabled to store a database, herein the database maintains a plurality of unstructured documents to be converted into flowcharts. Further, the system enables a plurality of instructions executable by the processor for applying natural language processing to parse the unstructured document into a plurality of events and identify a plurality of parameters associated with the events. Further, the system identifies correlation and execution sequence between the plurality of events using the plurality of parameters associated with the events. A parsed document storing the plurality of events is generated. The parsed document also maintains correlation and execution sequence of events in a structured format such as a binary tree structure. The parsed document is then used to generate a pictorially representation such as flow charts, flow diagrams, sequence and timeline diagrams representing the execution sequence of the events.

In one embodiment, the natural language processing is governed by a plurality of Artificial Intelligence algorithm to interpret the correlation and execution sequence between events. The plurality of parameters associated the events can be time of event, type of event, deadline of event, preceding event, succeeding event, loop structure of events and the like.

### BRIEF DESCRIPTION OF THE DRAWINGS

Having thus described the invention in general terms, reference will now be made to the accompanying drawings, which are not necessarily drawn to scale, and wherein:

FIG. 1 illustrates a distributed architecture for enabling natural language processing over a plurality of text documents;

FIG. 2 illustrates the different hardware and software modules involved for processing the text document;

FIG. 3 illustrates a Natural Language processing system implemented over a personal device for processing a text document;

FIG. 4 illustrates the conversion of text document into a structured document using the above system;

FIG. 5A-5D illustrates a two step process for converting a legal document into a flowchart; and

FIG. 6 illustrates a flow chart for generating the structured document from the text document.

### DETAILED DESCRIPTION OF THE INVENTION

Illustrative embodiments of the invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

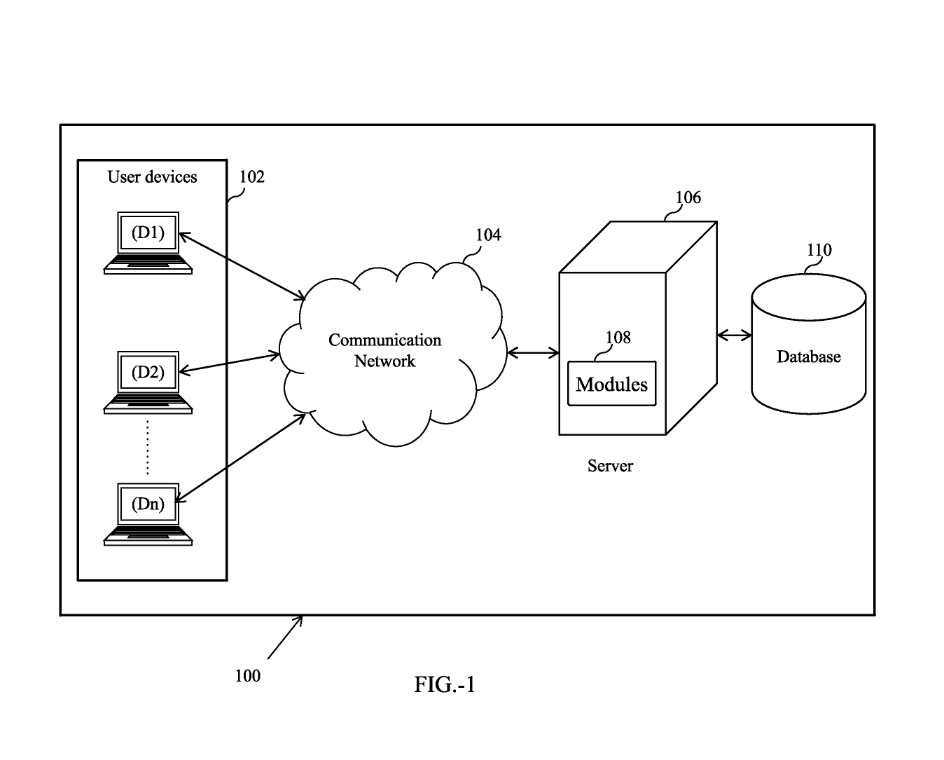

FIG. 1 illustrates a natural language processing system 100 where various embodiments of the invention function. The system 100 comprising a plurality of user devices 102 starting from D1, D2 to Dn connected over a communication network 104. In an embodiment, the user devices 102 can be anyone of a Desktop computer, a Laptop, a Tablet, a Smart phone and the like. Further the system 100 comprises a communication network 104, wherein the communication network 104 can be a network communication channel such as an Internet channel enabled over a broad band line or an optical fiber line. The communication network 104 enable to user device 102 to connect with a server 106. The server 106 stores a plurality of modules 108 for natural language processing of an unstructured document. The unstructured documents can be a legal contract, a business document, a business plan, a license agreements, an investment agreement, a term sheet, a memorandum of understandings, a complaint, a writ, an amendment, a motion, a brief, an affidavit, a real estate document, a real estate agreement, a set of rules, a lien, a note, a promissory note, an insurance contract, an estate planning, a statue, an executive order, an order, an employment agreement, an employment contract, a release forms, or a mortgage form. In one embodiment, the unstructured documents hereafter referred to as text documents are received at the server 106 from a plurality of user devices 102. These documents are further maintained at a database 110 connected to the server 106 for further processing. The server 106 maintains a plurality of modules 108 to process the text documents received from the user device 102 and accordingly generate flowcharts from these text documents using natural language processing. In one embodiment, the text document can be a legal contract, a business document, a business plan, license agreement and the like.

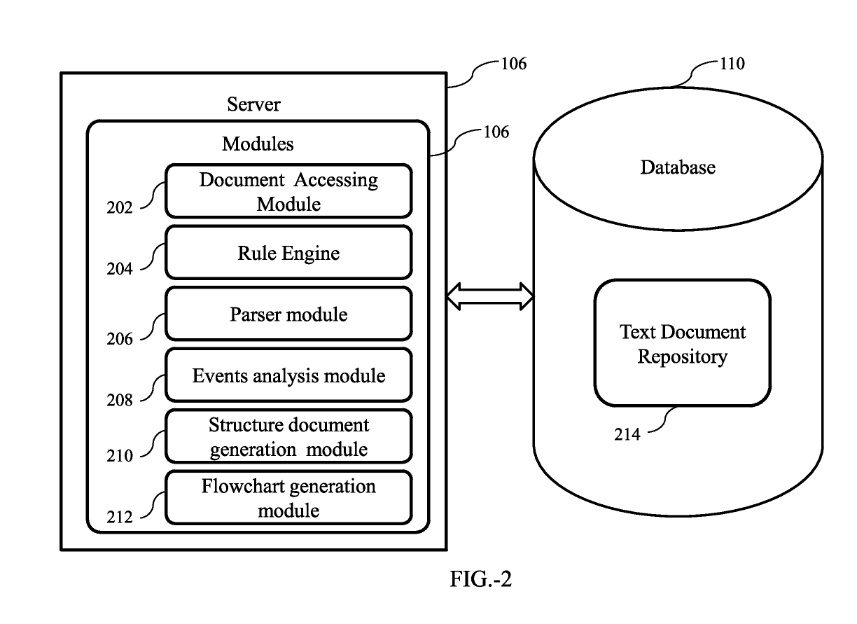

FIG. 2 illustrates the plurality of modules 108 implemented at the server 106 for processing a text document. The modules 108 are classified as a document accessing module 202, a Rule Engine 204, a parser module 206, an event analysis module 208, a structured document generation module 210, and a flowchart generation module 212. Further, the server 106 is connected to the Database 110, wherein the database 110 stores a plurality of text documents are received from a plurality of user devices 102 in a text document repository 214.

In one embodiment, based upon the request received from the user devices 102, the document accessing module 202 retrieves at least one text document from the text document repository 214. Alternately, the text document can retrieved from the user device 102 to the server 106 using known means of communication such as the internet. The document accessing module 202 performs preliminary analysis to determine the type of text document received from the user device 102. Based on the type of the text document, the parser module 206 is enabled to parse the text document into a plurality of events and a plurality of parameters associated with the events. The parser module 206 uses the rule engine 204 for this purpose. The rule engine 204 stores historical data and a set of predefined rules applied for parsing the text document. Further the parser module 206 applies a large variety of key words and expressions for parsing the text document. The keywords and expressions used for parsing are also maintained at the rule engine 204. Further, the structure document generation module 210 uses this information to generate a parsed document, wherein the parsed document is a structured document which stores the plurality of events extracted from the text document in a structured format. The parsed document is analyzed by the events analysis module 208 to identify the correlation and execution sequence associated with the events in the parsed document.

In one embodiment the parsed document is further processed by the Flowchart generation module 212 to generate a plurality of flowcharts. The flowcharts graphically represent the correlation and execution sequence of the events extracted from the text document.

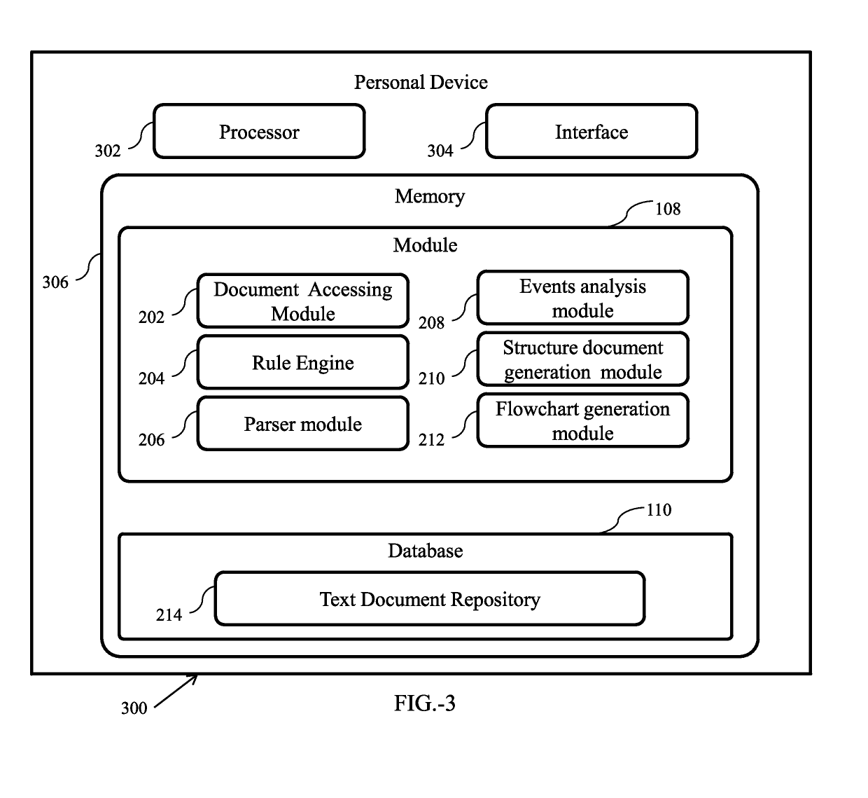

FIG. 3 illustrates the system for natural languages processing implemented over a personal device 300. The personal device comprises of a Processor 302, interface 304 and memory 306. The memory 306 is enabled to store the modules 108 and the Database 110. As described above, the modules 108 are classified as document accessing module 202, Rule Engine 204, parser module 206, event analysis module 208, structured document generation module 210, and a flowchart generation module 212. Further, the database 110 maintains the text document repository 214.

In one embodiment, the database 110 stores the text document repository 214 and based on the instruction received from the user, at least one text document is retrieved from the text document repository 214. The document accessing module 202 performs preliminary analysis to determine the type of text document received from the user device 102. Based on the type of the text document, the parser module 206 is enabled to parse the text document into a plurality of events and a plurality of parameters associated with the events. For this purpose, the parser module 206 uses the rule engine 204. The rule engine 204 stores historical data and a set of predefined rules applied for parsing the unstructured document. Further the parser module 206 applies a large variety of key words and expressions for parsing the text document. The keywords and expressions used for parsing are also maintained at the rule engine 204. Further, the structure document generation module 210 uses this information to generate a parsed document, wherein the parsed document is a structured document which stores the plurality of events extracted from the text document in a structured format. The parsed document is analyzed by the events analysis module 208 to identify the correlation and execution sequence associated with the events in the parsed document. The parsed document is further processed by the Flowchart generation module 212 to generate a plurality of flowcharts. The flowcharts graphically represent the correlation and execution sequence of the events extracted from the text document.

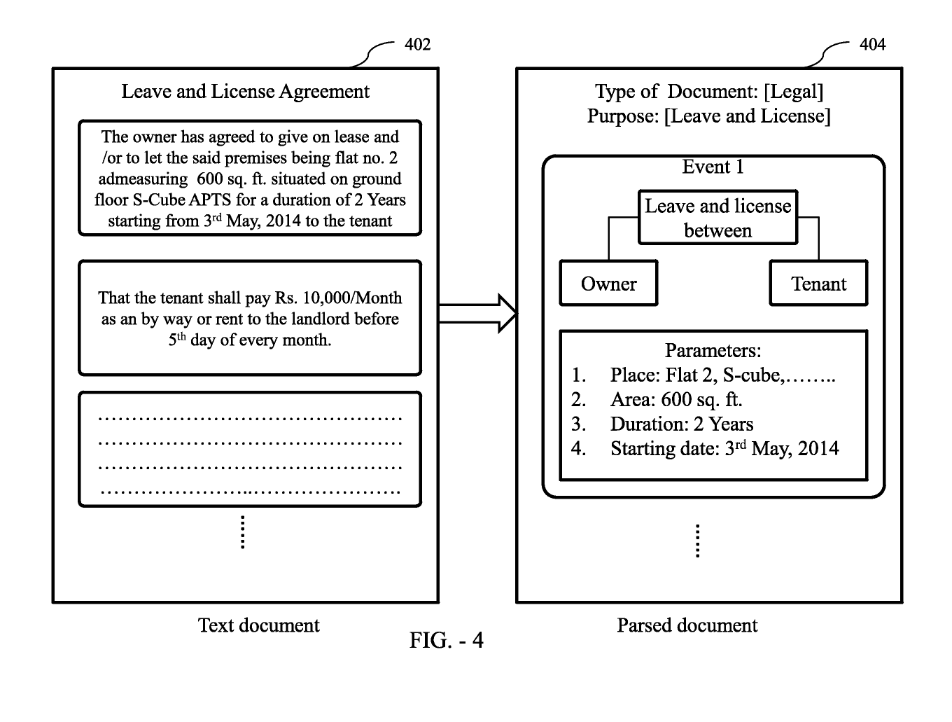

FIG. 4 illustrates the process for converting a text document 402 into a parsed document 404 using the natural language processing system 100. The text document 402 stores information in natural language format. At the first step, preliminary analysis is performed on the text document 402 to determine the type of text document 402. For this purpose standard keywords are compared with the title of the document abstract and other important texts are compared with the standard rules. Further, the text document 402 is divided into a plurality of events. The text document can be divided using a set of predefined rules like pointers, numbering, headings which are stored in the rule engine 204. The rule engine 204 stores historical data and a set of predefined rules which are applied for parsing the text document. The keywords and expressions used for parsing are also maintained at the rule engine 204. Once the text document 402 is broken down into a plurality of events, each of the individual events is analyzed to identify the set of parameters associated with each of the events. In the next step, the structure document generation module 210 uses this information to generate a parsed document 404, wherein the parsed document is a structured document which stores the plurality of events extracted from the text document in a structured format.

As disclosed in FIG. 4, each of the events identified from the text document is stored into two parts, first is the entities involved and second is the parameters associated with each of the entities. The entities involved are maintained in a binary tree structure which is easy to interpret. The parsed document 404 is further processed to generate a plurality of flowcharts. The flowcharts graphically represent the correlation and execution sequence of the events.

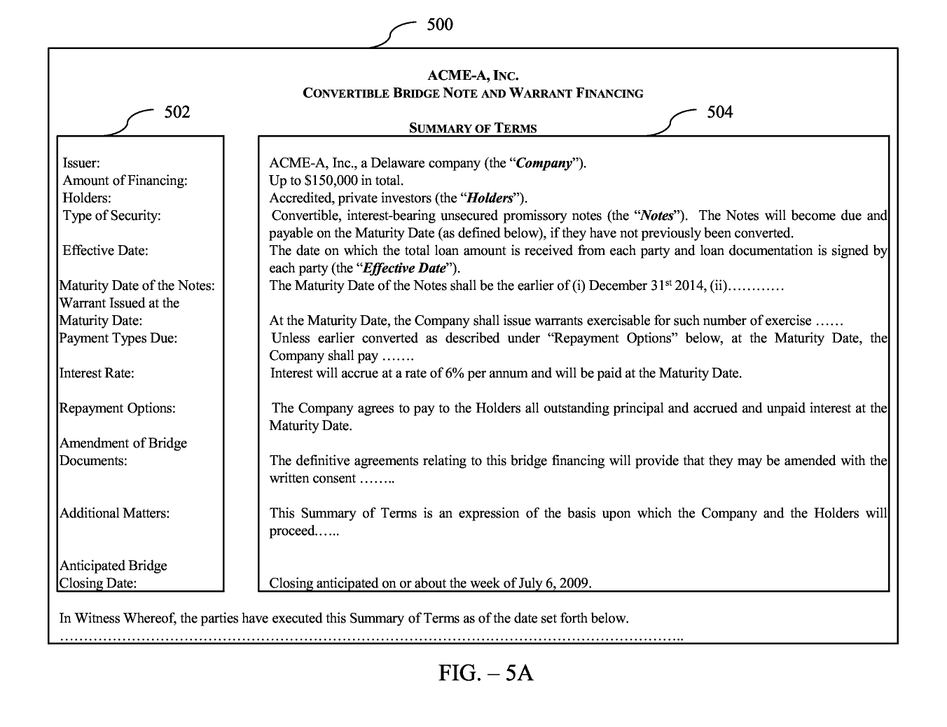

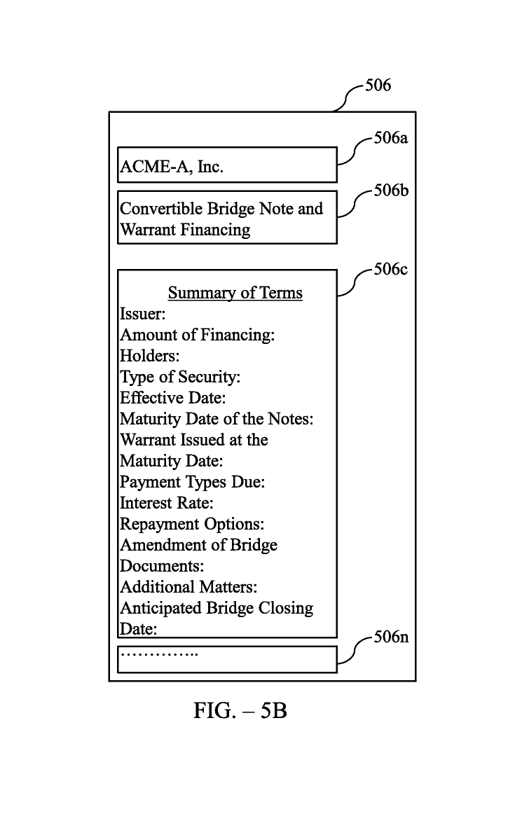

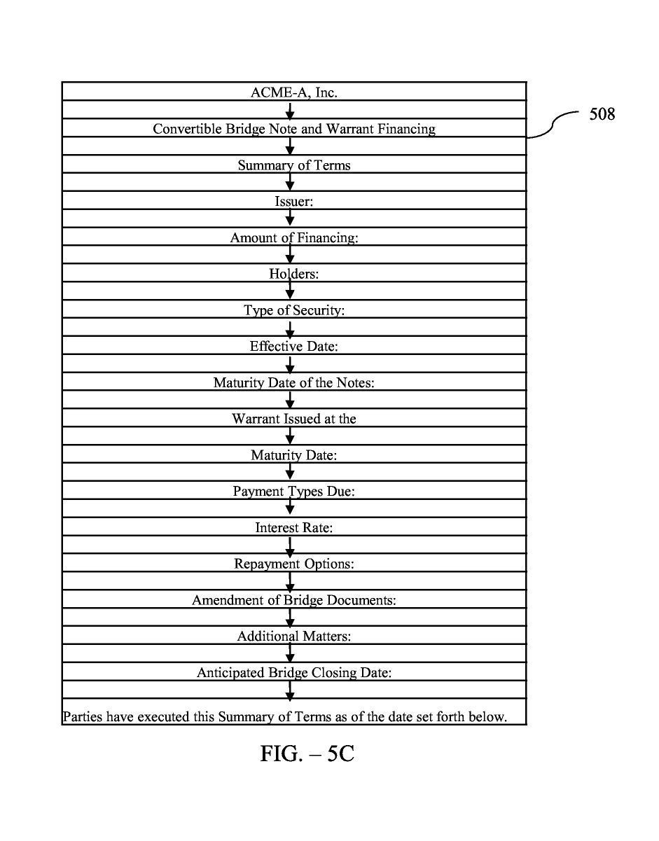

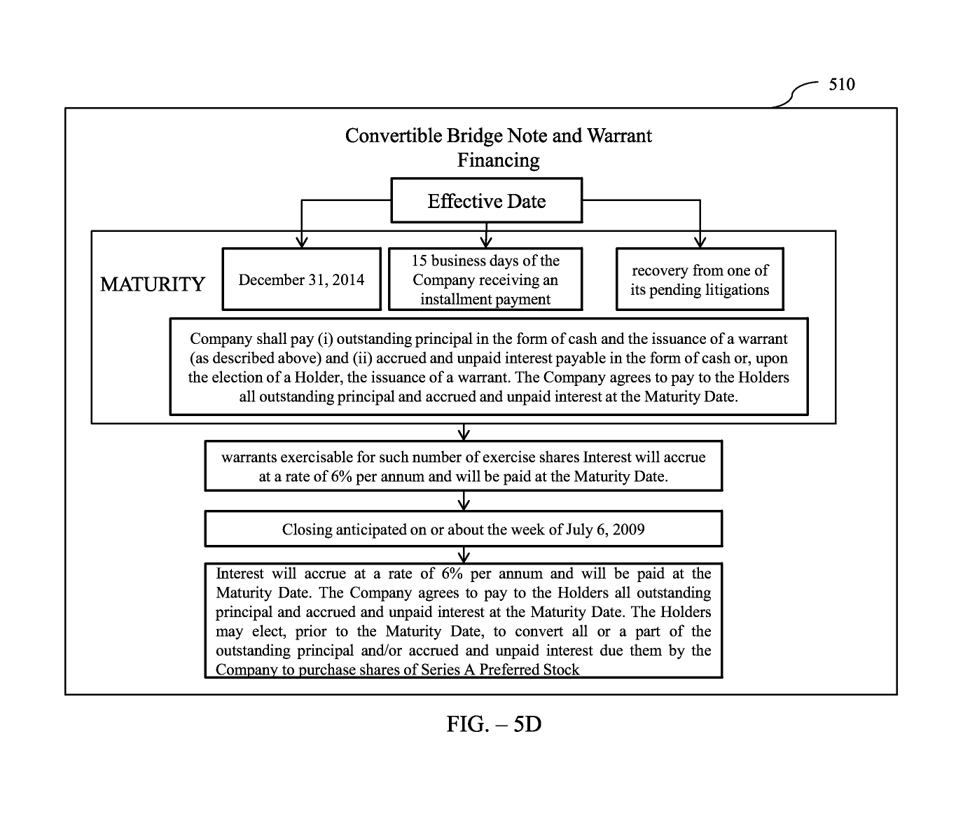

FIG. 5A-5D illustrates a two step process for converting a document into a flowchart. FIG. 5A discloses a legal document 500 for “Convertible Bridge Note and Warrant Financing”. The legal document 500 is broadly classified into two parts namely a plurality of terms 502 and a summary of the terms 504. The plurality of terms 502 include all the conditions on which the legal document 500 is based. The summary of the terms 504 describe each of the terms in detail and the conditions associated with each of the plurality of terms 502. Further, the parser module 206 examines the legal document 500 to identify the plurality of terms 502 and summary of the terms 504 associated with the legal document 500. In one embodiment, the parsing of the legal document 500 is classified as parsing phase one and parsing phase two. The parsing phase one is explained in FIG. 5B and the parsing phase two is explained in FIG. 5C.

FIG. 5B represent a primary parsed document 506 generated by the parser module 206 after performing parsing phase one. In the parsing phase one, the legal document 500 is analyzed by the parser module 206 to extract the plurality of term 502 and converts them into highlights 506a-506n. Further, in the parsing phase two, the key highlights 506a-506n are further processed to identify the correlation between them and accordingly a structured parsed document 508 is generated as represented in FIG. 5C. This document contains the correlation between the key highlights 506a-506n of the legal document 500. The structured parsed document 508 is then used to generate a pictorially graphical representation such as flow charts, flow diagrams, sequence or timeline diagrams representing the execution sequence of the events in the legal document 500.

FIG. 5D represents a flowchart 510 generated from the structured parsed document 508. For the purpose of generating the flowchart 510, the flowchart generation module 212 analyzes the structured parsed document 508 and generates graphical representation of the flow between the key highlights 506a-506n and summary of the terms 504 of the legal document 500. The flowchart generation module 212 also uses natural language processing to identify branching statements and the correlation between the key highlights of the legal document 500.

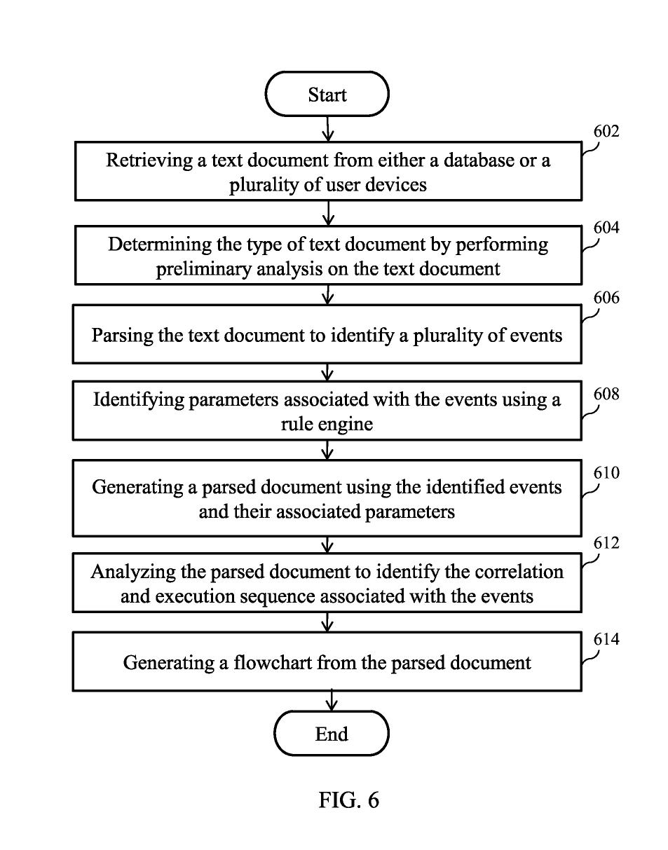

FIG. 6 illustrates a flowchart for the process of transforming the text document into a flowchart. At step 602, the text document is retrieved from user device 102. Alternately all the text documents can be maintained in the database 110 associated with the natural language processing system 100. One of these text documents is retrieved for processing at the server of the natural language processing system 100. At step 604, these documents are analyzed to identify the type of text document by performing preliminary analysis on the text document. The text document can be identified as a legal document, a business document, process planning document, or any other type of document which discloses a plurality of events/steps to achieve a particular task. At step 606, the text document is parsed based on the type of the text documenting order to identify a plurality of events which are present in the text document using the parser module 206. The parser module 206 applies a large variety of key words and expressions for parsing the text document. Further, at step 608, the parser module 206 uses the rule engine 204 to identify a plurality of parameters associated with the events. The rule engine 204 stores historical data and a set of predefined rules applied for parsing the unstructured document and identifying the set of parameters associated with the events present in the text document.

In one embodiment, once the text document is analyzed for identifying the events and associated parameters, at step 610, a parsed document is generated using the identified events and their associated parameters. The structure document generation module 210 uses the information associated with the events and parameters to generate the parsed document, wherein the parsed document is a structured document which stores the plurality of events extracted from the text document in a structured format. At step 612, the parsed document is analyzed by events analysis module 208 to identify the correlation and execution sequence associated with the events. At step 614, the parsed document is further processed by the Flowchart generation module 212 to generate a plurality of flowcharts. The flowcharts graphically represent the correlation and execution sequence of the events extracted from the text document.

Embodiments of the invention are described above with reference to block diagrams and schematic illustrations of methods and systems according to embodiments of the invention. It will be understood that each block of the diagrams and combinations of blocks in the diagrams can be implemented by computer program instructions. These computer program instructions may be loaded onto one or more general purpose computers, special purpose computers, or other programmable data processing translator to produce machines, such that the instructions which execute on the computers or other programmable data processing translator create means for implementing the functions specified in the block or blocks. Such computer program instructions may also be stored in a computer-readable memory that can direct a computer or other programmable data processing apparatus to function in a particular manner, such that the instructions stored in the computer-readable memory produce an article of manufacture including instruction means that implement the function specified in the block or blocks.

While the invention has been described in connection with what is presently considered to be the most practical and various embodiments, it is to be understood that the invention is not to be limited to the disclosed embodiments, but on the contrary, is intended to cover various modifications and equivalent arrangements included within the spirit and scope of the appended claims. The invention has been described in the general context of computing devices, phone and computer-executable instructions, such as program modules, being executed by a computer. Generally, program modules include routines, programs, characters, components, data structures, etc., that perform particular tasks or implement particular abstract data types. A person skilled in the art will appreciate that the invention may be practiced with other computer system configurations, including hand-held devices, multiprocessor systems, microprocessor-based or programmable consumer electronics, network PCs, minicomputers, mainframe computers, and the like. Further, the invention may also be practiced in distributed computing worlds where tasks are performed by remote processing devices that are linked through a communications network. In a distributed computing world, program modules may be located in both local and remote memory storage devices.

This written description uses examples to disclose the invention, including the best mode, and also to enable any person skilled in the art to practice the invention, including making and using any devices or systems and performing any incorporated methods. The patentable scope the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for converting an unstructured document to a plurality of flowchart using natural language processing, the method comprising processor implemented steps of:
retrieving the unstructured document from a database;
parsing the unstructured document to identify a plurality of events and a plurality of parameters associated therewith, wherein a set of predefined rules are applied for parsing the unstructured document;
identifying correlation and execution sequence between the plurality of events, using the plurality of parameters associated with the events;
generating a parsed document storing the plurality of events with the correlation and execution sequence associated therewith in a structured format, wherein the structured format is a binary tree structure; and
generating a pictorially representation of the execution sequence of the events captured in the parsed document.

2. The method of claim 1, wherein the unstructured document can be a legal contract, a business document, a business plan, a license agreements, an investment agreement, a term sheet, a memorandum of understandings, a complaint, a writ, an amendment, a motion, a brief, an affidavit, a real estate document, a real estate agreement, a set of rules, a lien, a note, a promissory note, an insurance contract, an estate planning, a statue, an executive order, an order, an employment agreement, an employment contract, a release forms, or a mortgage form.

3. The method of claim 1, wherein the natural language processing is applied using a large variety of key words and expressions.

4. The method of claim 3, wherein the natural language processing is governed by a plurality of Artificial Intelligence algorithm to interpret the correlation and execution sequence between events.

5. The method of claim 1, wherein the plurality of parameters associated with the events can be time of event, type of event, deadline of event, preceding event, succeeding event, loop structure of events.

6. The method of claim 5, wherein the plurality of parameters associated with the events can be a milestone, a requirement, a payment, and a deliverable timelines.

7. The method of claim 1, wherein the pictorially representation includes flow charts, flow diagrams, sequence and timeline diagrams for representing the different relation between different events.

8. A system for converting an unstructured document to a plurality of flowchart using natural language processing, the system comprising:
a processor;
a memory couplet to the processor, the memory comprising:
a database storing a plurality of unstructured documents; and
a plurality of instructions executable by the processor for:
parsing the unstructured document to identify a plurality of events and a plurality of parameters associated therewith, wherein a set of predefined rules are applied for parsing the unstructured document;
identifying correlation and execution sequence between the plurality of events, using the plurality of parameters associated with the events;
generating a parsed document storing the plurality of events with the correlation and execution sequence associated therewith in a structured format, wherein the structured format is a binary tree structure; and
generating a pictorially representation of the execution sequence of the events captured in the parsed document.

9. The system of claim 8, wherein the unstructured document can be a legal contract, a business document, a business plan, a license agreements, an investment agreement, a term sheet, a memorandum of understandings, a complaint, a writ, an amendment, a motion, a brief, an affidavit, a real estate document, a real estate agreement, a set of rules, a lien, a note, a promissory note, an insurance contract, an estate planning, a statue, an executive order, an order, an employment agreement, an employment contract, a release forms, or a mortgage form.

10. The system of claim 8, wherein the natural language processing is applied using a large variety of key words and expressions.

11. The system of claim 10, wherein the natural language processing is governed by a plurality of Artificial intelligence algorithm to interpret the correlation and execution sequence between events.

12. The system of claim 8, wherein the plurality of parameters associated with the events can be time of event, type of event, deadline of event, preceding event, succeeding event, loop structure of events.

13. The system of claim 12, wherein the plurality of parameters associated with the events can be a milestone, a requirement, a payment, and a deliverable timelines.

14. The system of claim 8, wherein the pictorially representation includes flow charts, flow diagrams, sequence and timeline diagrams for representing the different relation between different events.
